(19) United States
(12) Patent Application Publication
(10) Pub. No.: US 2007/0297290 A1
(43) Pub. Date: Dec. 27, 2007

(54) Systems and Methods for Providing Connectivity in an Underwater Environment

(76) Inventors: Frederick Vosburgh, Durham, NC (US); Ryan Moody, Durham, NC (US); Mathieu P. Kemp, Durham, NC (US)

Correspondence Address: MYERS BIGEL SIBLEY & SAJOVEC, PO BOX 37428, RALEIGH, NC, 27627, US

(21) Appl. No.: 11/566,899

(22) Filed: Dec. 5, 2006

Related U.S. Application Data
(60) Provisional application No. 60/749,428, filed on Dec. 12, 2005.

(51) Int. Cl. H04B 11/00

(52) U.S. Cl. 367/131

(57) ABSTRACT

A system for providing connectivity in an underwater environment includes a linking system, a target and a linking member. The linking system includes a first base and an unmanned, submersible mobile unit. The target is remote from the first base. The linking member is connected to one of the first base and the target. The mobile unit is operative to autonomously convey the linking member through the underwater environment from the first base to the target and/or from the target to the first base to interconnect the first base and the target via the linking member. According to some embodiments, the linking member is a flexible connecting line.

### RELATED APPLICATION(S)

This application claims the benefit of and priority from U.S. Provisional Patent Application Ser. No. 60/749,428, filed Dec. 12, 2005, the disclosure of which is incorporated herein by reference in its entirety.

### STATEMENT OF GOVERNMENT SUPPORT

This invention was made with support under Small Business Innovation Research (SBIR) Program No. N66604-05-C-0287 awarded by the United States Navy. The Government has certain rights in the invention.

### FIELD OF THE INVENTION

The present invention relates to water submersible devices and methods for connecting the same.

### BACKGROUND OF THE INVENTION

Monitoring of the oceans for purposes of scientific research, national defense, or commercial development is becoming increasingly automated to reduce costs. Evidence of this is the emergence of unmanned undersea vehicles (UUV) as key tools in the offshore engineering industry. Considerable investment is being made by nations around the world to develop UUV for national or homeland defense. Today, while UUV are suited to relatively straight forward tasks such as bathymetric surveys, they have yet to supplant divers in more complex tasks, such as servicing underwater monitoring devices, in part because recharging a device or retrieving data requires a connection between the device and its service unit requires manual dexterity to provide precise mating of costly devices that once connected isolate electrodes from surrounding water. While a straight forward task for an operator on land, such connection devices are beyond the capabilities of cost effective autonomous vehicles.

With the increasing requirement for persistent intelligence, surveillance and reconnaissance (ISR) operations in areas where access is denied or where ISR is otherwise desirably covert, UUV will be increasingly put to use. Use of UUV in servicing devices historically tended by submarines, deep submersible vehicles and divers will provide considerable financial savings while also reducing risk to the operators.

Persistent ISR and other activities in problematic areas drives the need for means of connecting devices together that does not require human intervention or costly engineering systems that make UUV uneconomic.

### SUMMARY OF THE INVENTION

According to embodiments of the present invention, a system for providing connectivity in an underwater environment includes a linking system, a target and a linking member. The linking system includes a first base and an unmanned, submersible mobile unit. The target is remote from the first base. The linking member is connected to one of the first base and the target. The mobile unit is operative to autonomously convey the linking member through the underwater environment from the first base to the target and/or from the target to the first base to interconnect the first base and the target via the linking member. According to some embodiments, the linking member is a flexible connecting line.

According to method embodiments of the present invention, a method for providing connectivity in an underwater environment includes: providing a linking system including a first base and an unmanned, submersible mobile unit; and using the mobile unit, autonomously conveying a linking member connected to one of the first base and a remote target through the underwater environment from the first base to the target and/or from the target to the first base to interconnect the first base and the target via the linking member.

According to embodiments of the present invention, a system for providing connectivity in an underwater environment includes a submersible first unit and a submersible second unit. The submersible first unit includes a first connector. The submersible second unit includes a second connector configured to inductively couple with the first connector to inductively transmit power and/or data between the first and second units. According to some embodiments, the second connector is configured to releasably engage the first connector. According to some embodiments, the first unit is an unmanned submersible vehicle.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a flowchart illustrating methods according to embodiments of the present invention.

FIG. 2 is a perspective view of an underwater connectivity system according to embodiments of the present invention.

FIG. 3 is a perspective view of a linking system forming a part of the connectivity system of FIG. 2.

FIG. 4 is a perspective view of a target system forming a part of the connectivity system of FIG. 2.

FIG. 5 is a fragmentary perspective view of the connectivity system of FIG. 2.

FIG. 6 is an enlarged, fragmentary perspective view of the connectivity system of FIG. 2.

FIG. 7 is an enlarged, fragmentary cross-sectional view of a receptacle and connectors forming a part of the connectivity system of FIG. 2.

FIG. 8 is a perspective view of an underwater connectivity system according to further embodiments of the present invention.

FIG. 9 is a perspective view of an underwater connectivity system according to further embodiments of the present invention.

FIG. 10 is a perspective view of an underwater connectivity system according to further embodiments of the present invention.

### DETAILED DESCRIPTION EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the electronics device in use or operation in addition to the orientation depicted in the figures. For example, if the electronics device in the figures is turned over, elements described as “under” or “beneath” other elements or features would then be oriented “over” the other elements or features. Thus, the exemplary term “under” can encompass both an orientation of over and under. The electronics device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Well-known functions or constructions may not be described in detail for brevity and/or clarity.

As used herein, a “signal” can be a signal of any suitable type, such as an acoustic, optical, image, radio, electrical, magnetic, electromagnetic, and/or mechanical signal. In some cases, signals can include additional information such as an identifier, a time/date, a location, a classification, a signature, or a command. In some cases, signals can represent environmental parameters such as conductivity, temperature, depth, water current, turbulence, luminescence, turbidity, presence or concentration of dissolved oxygen, pH, chlorophyll presence or concentration, or acoustic noise.

As used herein, “line” may include any suitable elongate connecting element such as a cable, hose, tube, conduit or the like.

As used herein, “base” may refer to an object that is stationary, mobile, and/or capable of mobility.

As used herein, “submersible” means an object that is water submersible and constructed such that electronic and other water sensitive components thereof are protected from contact with the surrounding water.

Systems and apparatus according to embodiments of the present invention may be used to provide connections between objects or units in an underwater environment. According to some embodiments, devices and methods according to embodiments of the present invention may autonomously establish a data, power and/or mechanical connection between two objects without prior knowledge of the relative positions of the two objects. Devices and methods of the present invention may be used, for example, to connect an unmanned underwater vehicle (UUV), sensor or communications device to an energy supply or source, or to connect a sensing system to a UUV or communications device for data transfer. In particular, such devices and methods may be used to autonomously interconnect devices where prior knowledge of relative position is not readily available.

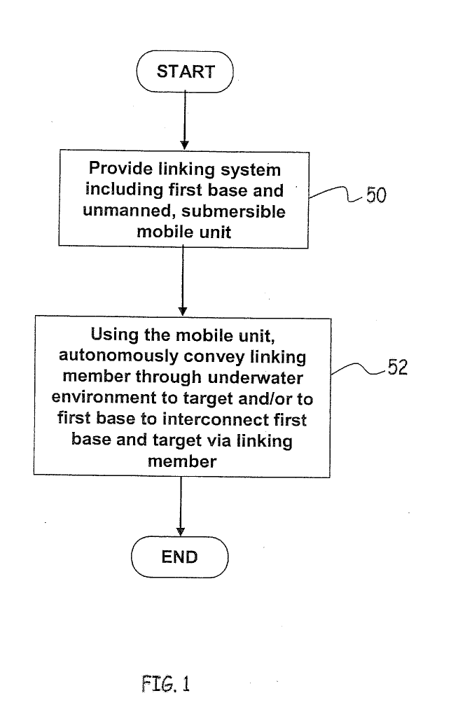

With reference to FIG. 1, methods for providing connectivity in an underwater environment according to embodiments of the present invention may include providing a linking system including a first base and an unmanned, submersible mobile unit (Block 50). Using the mobile unit, a linking member connected to one of the first base and a remote target is autonomously conveyed through the underwater environment to the target and/or to the first base to interconnect the first base and the target via the linking member (Block 52). According to some embodiments, the mobile unit autonomously conveys the linking member through the underwater environment from proximate the first base to the target. According to some embodiments, the mobile unit autonomously conveys the linking member through the underwater environment from proximate the target to the first base.

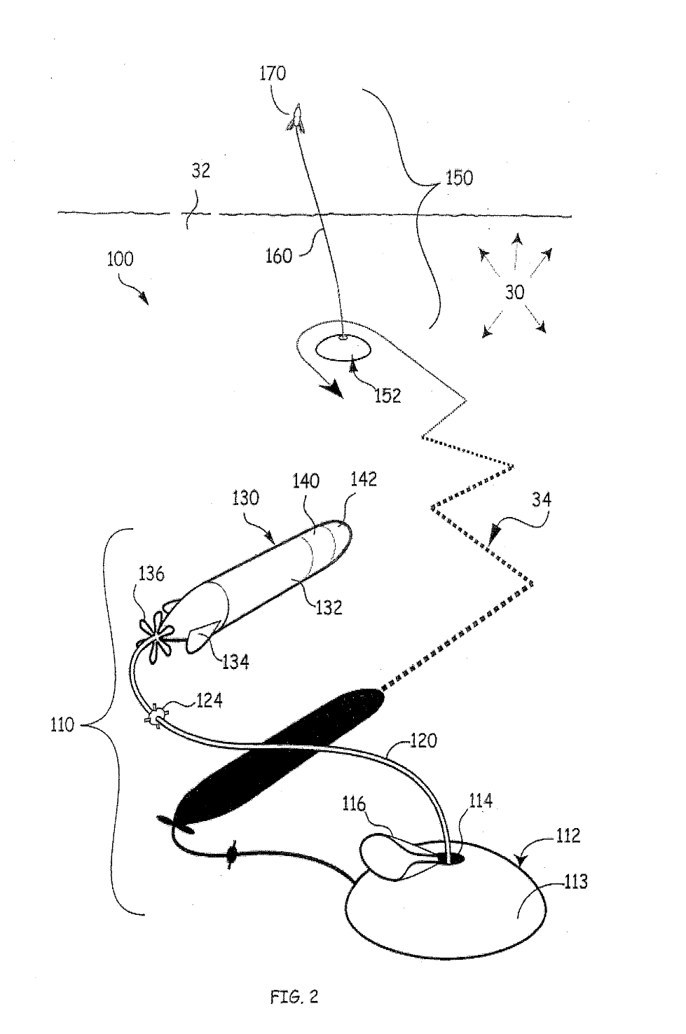

With reference to FIGS. 2-7, an underwater connectivity system 100 according to embodiments of the present invention is shown therein in a body of water 30 (e.g., a sea or ocean) overlying a floor 32 (e.g., a sea floor). The system 100 includes a linking system 110 and a target or target system 150. Generally, in the system 100 the linking system 110 may operate to form a connection link between the bases 112 and 152 in the water 30.

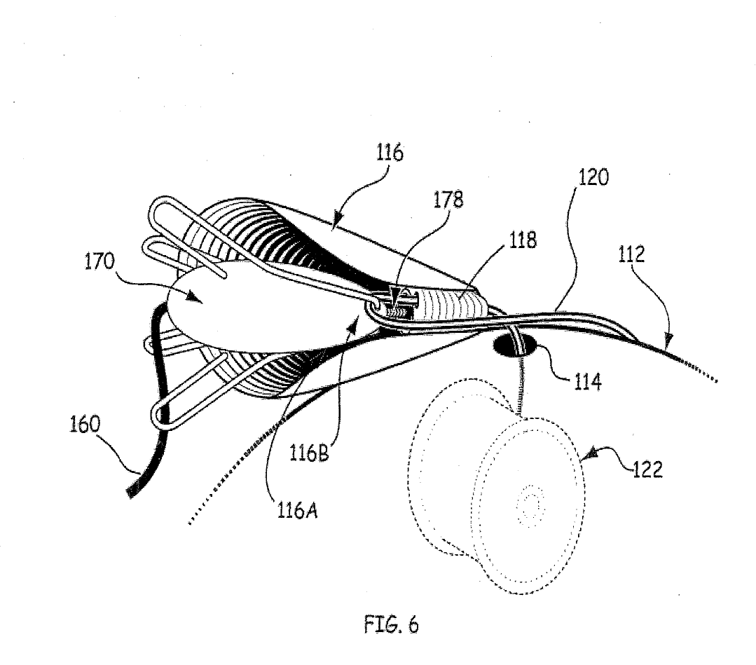

Turning to the linking system 110 in more detail, the linking system 110 includes a base 112, a retrieval line or tether 120, and an unmanned underwater vehicle (UUV), retriever, or shuttle 130. The base 112 includes a housing 113 defining a portal or opening 114. A receptacle 116 is mounted on or in the housing 113. Referring to FIG. 6, a connector 118 is positioned proximate the receptacle 116 and may include an inductive coupling device 118A as discussed below.

The UUV 130 serves as a mobile unit and may be any suitable unmanned, water submersible mobile unit. The UUV 130 includes a body 132, a steering mechanism 134 (e.g., a rudder), a propulsion mechanism 136 (e.g., a power driven propeller), a controller 140, and a navigation system 142 (which may include one or more suitable sensors or detectors). The UUV 130 may include a power source mounted on the body 132. Suitable UUVs may include a UUV as disclosed in Applicant's co-pending U.S. patent application Ser. No. 11/495,134, filed Jul. 28, 2006, titled “Underwater Guidance Systems, Unmanned Underwater Vehicles and Methods,” the disclosure of which is incorporated herein by reference.

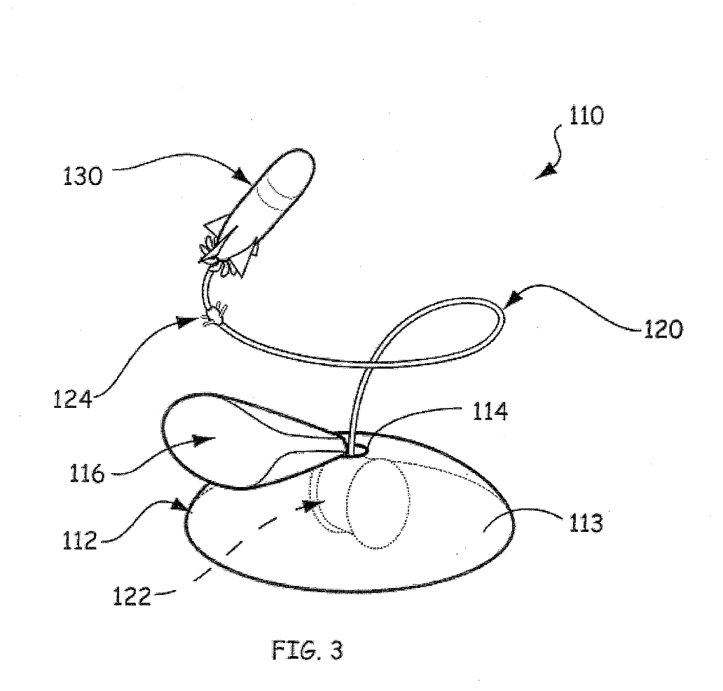

The tether 120 is mechanically secured to the base 112 and the UUV 130 at opposed ends of the tether 120 and thereby mechanically connects the base 112 to the UUV 130. The tether 120 extends through the opening 114 and from a reel 122 (FIGS. 3 and 6) in the base 112. A stop or engagement member 124 is mounted on the tether 120. The tether 120 may be constructed in any suitable manner. According to some embodiments, the tether 120 is flexible. According to some embodiments, the tether 120 is flexible without preference in bending direction.

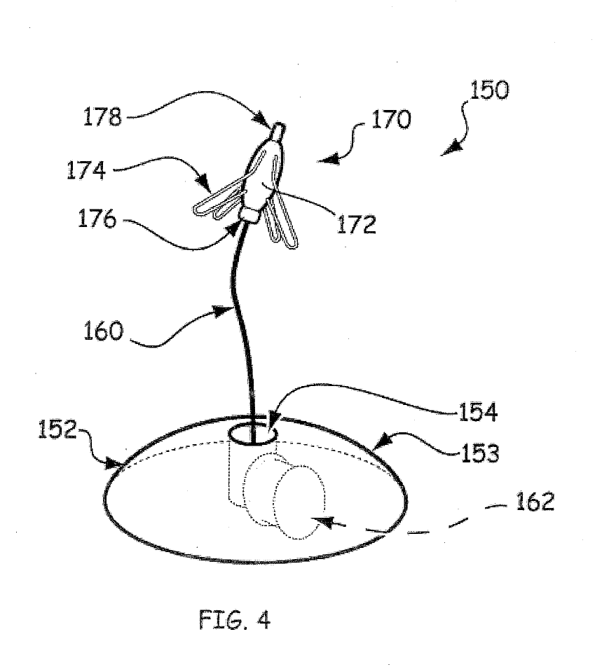

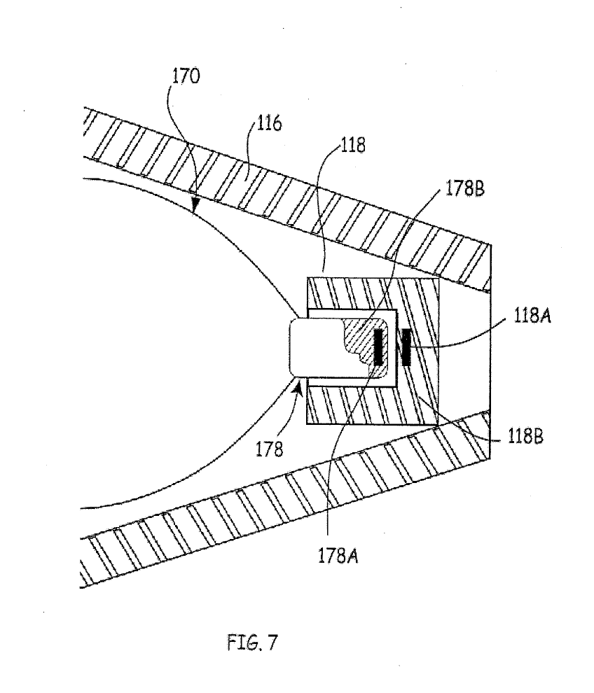

The target system 150 includes a base 152, a connecting line 160 and a connector 170. With reference to FIG. 4, the base 152 includes a housing 153 defining a portal or opening 154. The connecting line 160 extends through the opening 154 and from a reel 162 in the base 152. The connector 170 is mounted on the connecting line 160. The connector 170 includes a body 172, one or more line capture structures 174 (e.g., barbs), an emitter 176, and a locator prong or connector 178. The connector 170 may include an inductive coupling element 178A (FIG. 7) in the connector 178 as discussed below. According to some embodiments, the connecting element can be an optical component operative in water. One example optical component comprises an LED for data sending and/or a photodiode for data receiving. According to some embodiments, the connector 170 has a positive buoyancy so that it can serve as a float to buoy up a portion of the connecting line 160.

The connecting line 160 may be constructed in any suitable manner for the intended application, as discussed in more detail herein. According to some embodiments, the connecting line 160 is flexible. According to some embodiments, the connecting line 160 is flexible without preference in bending direction.

Operation of the system 100 in accordance with some embodiments of the present invention will now be described with reference to FIGS. 2-7. When it is desired to form a connection between the base 112 and the target system 150, the UUV 130 is deployed such that it travels through the water 30 along a path 34 from proximate the base 112 to the target system 150 as indicated in FIG. 2. The UUV 130 may be propelled under its own power by the onboard propulsion mechanism 136. A length of the connecting line 160 may be paid out from the base 152 so that the connector 170 is disposed or floats some distance from the base 152 and the connecting line 160 is exposed as shown in FIGS. 2 and 4.

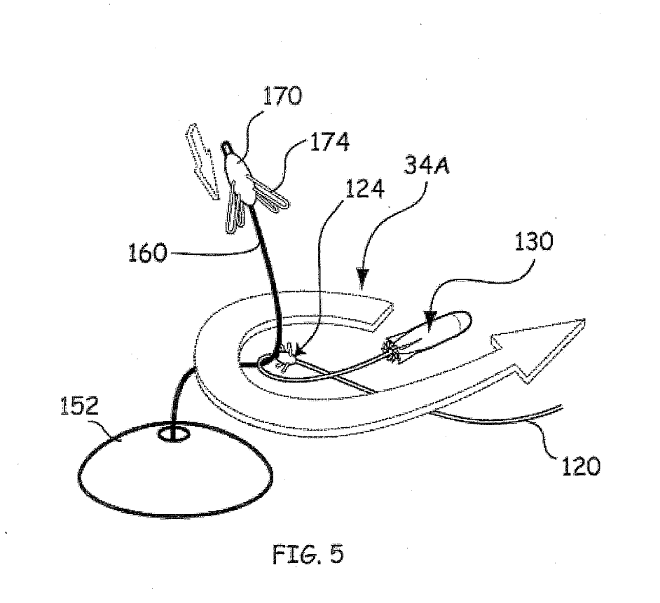

The tether 120 may be paid out as the UUV 130 moves away from the base 112. Once the UUV 130 reaches the target system 150, the UUV 130 circles the connecting line 160 so that the tether 120 travels in a loop 34A around the connecting line 160 (as shown in FIG. 5) and captures or is captured by the connecting line 160 and/or the connector 170. The line capture guide 174 may serve to couple the connector 170 to the tether 120 by physically coupling, engaging and/or interlocking with the stop 124, for example.

The UUV 130 then returns toward the base 112, thereby conveying the connector 170 and the connecting line 160 back to the base 112. The tether 120 may be taken up by the reel 122 as the UUV 130 returns. According to some embodiments, the UUV 130 and the connector 170 are drawn back to the base 112 by the tether 120 and the reel 122 alone. According to other embodiments, the UUV 130 and the connector 170 are returned to the base 112 under the power of the UUV 130 alone (e.g., by the propulsion mechanism 136). According to still further embodiments, the UUV 130 and the connector 170 are returned to the base 112 under the power of both the UUV 130 and the reel 122.

As shown in FIG. 6, the UUV 130 and the tether 120 draw the connector 170 into the receptacle 116, where an operative connection is formed between the connectors 118 and 178. The receptacle 116 and the opening 114 or reel 122 may be relatively positioned to direct the connector 170 into the receptacle 116 as the tether 120 is taken up by the reel 122. In this manner, the UUV 130 retrieves the connector 170 and the connecting line 160.

As discussed in more detail herein, the connecting line 160 may serve to physically anchor the base 152 to the base 112 and/or energy, data and/or media may be transferred between the bases 112, 152 over the connecting line 160. When the connection via the connecting line 160 is no longer needed or desired, the connecting line 160 and/or the connector 170 can be released by the tether 120 and returned to proximate the base 152 using the reel 162.

While, in accordance with the foregoing description, the stop 124 and the line capture guide 174 serve to couple the tether 120 and the connecting line 160 or the connector 170, other mechanisms may be employed. Such other mechanisms may serve to snare, hook, clamp, grab, latch, entangle, adhere, magnetically hold or otherwise secure the tether 120 and the connecting line 160 or the connector 170.

The controller 140 and the navigation system 142 may guide the UUV 130 to and about the target system 150 in any suitable manner. According to some embodiments, the navigation system 142 includes a signal emission responsive guidance and control system that detects (by means of one or more signal emission sensors) a deliberate or incidental signal from the target system 150 and navigates in response to the signal. According to some embodiments, the emitter 176 emits a beacon or other type signal that the navigation system 142 uses to home in on the target system 150. In this manner, the UUV 130 can establish the connection between the bases 112, 152 even when the target system 150 is located at an unknown location. According to some embodiments, the navigation system 142 uses positioning data provided via signals from another source or sources in combination with known coordinates of the target system 150. The navigation signals emitted and detected may include, for example, acoustic, sonar, optical, magnetic, radio, electrical and/or mechanical signals. The controller 140 and the navigation system 142 may comprise an autopilot function. Suitable navigation systems and methods for the navigation system 142 may include navigation systems and methods as described in Applicant's co-pending U.S. patent application Ser. No. 11/495,134, filed Jul. 28, 2006, titled “Underwater Guidance Systems, Unmanned Underwater Vehicles and Methods,” the disclosure of which is incorporated herein by reference.

According to some embodiments, the connecting line 160 is used to provide a desired transfer between the systems 110, 150. Such transfer may occur from the base 112 to the base 152, from the base 152 to the base 112, or both. That is, either or both of the systems 110, 150 can be a supplier and/or a receiver.

According to some embodiments, energy or power is electrically transferred between the base 112 and the base 152 via the connecting line 160. The energy may be transferred electrically, magnetically, chemically, thermally, and/or as a solid, liquid or gas, for example.

According to some embodiments, data signals (analog or digital) are transferred between the base 112 and the base 152 via the connecting line 160. Such data signals may be transmitted electrically (including magnetically, capacitively, and/or inductively), optically, acoustically, molecularly, mechanically, chemically, thermally or using pressure, tension or vibration.

According to some embodiments, material or media (such as fuel media or collected samples) is transferred between the base 112 and the base 152 via the connecting line 160. According to some embodiments, the fuel media includes an organic, biomass, and/or chemical fuel media. According to some embodiments, the media is fuel media such as organic material, methane hydrate, methane, methanol, or another suitable electron donor for conversion in a fuel cell.

The construction of the connecting line 160 will correspond at least in part with the type of transfer to be conducted via the cable. The connecting line 160 may include an electrically conductive cable (e.g., including one or more electrically conductive wires) for the transfer of electrical power and/or electrical data signals. The connecting line 160 may include optical fiber for the transfer of optical data signals. The connecting line 160 may include a tubular conduit defining a through passage for the transfer of pressure or media such as fuel or other media (e.g., in a liquid and/or gas state). The connecting line 160 may include multiple transfer elements or paths of one or more types. For example, the connecting line 160 may include both an electrical conductor for transmission of electrical power and/or electrical data signals and an optical fiber for the transmission of optical data signals. The connecting line 160 may include a protective jacket or the like to protect the transmission components.

According to some embodiments, the connecting line 160 is used to electrically inductively transfer power and/or data signals between the bases 112, 152 via the connectors 118, 178. With reference to an exemplary embodiment as shown in FIG. 7, the connector 118 includes an inductive coupling device 118A and an electrically non-conductive or dielectric cover 118B. In some cases, the coupling device or connector 118 can comprise an optical component operative in seawater. The prong 178 of the connector 170 includes an inductive coupling device 178A and an electrically non-conductive or dielectric cover 178B. The inductive coupling devices 118A, 178A may be electrically conductive members configured in a suitable manner such as in the form of a wire, coil, loop, polygon, plate, antenna or patch. The covers 118B, 178B may be formed of any suitable electrically non-conductive material that permits magnetic fields to pass therethrough, such as a polymeric material. The inductive coupling devices 118A, 178A are sealed by the covers 118B, 178B so that they do not come in contact with or in electrical continuity with the water 30. When the connector 170 is seated in the receptacle 116, the inductive coupling devices 118A, 178A are positioned proximate one another to enable inductive coupling therebetween. Because the inductive coupling devices 118A, 178A are sealed from the water, the connection system allows for convenient and reliable mateability in water of the connectors 118, 170 without requiring electrical isolation. The relative arrangement and configurations of the connectors 118, 170 and the receptacle 116 may enable self-seating of the connectors 118, 170 to provide a self-seating inductive connector assembly. The opposing faces of the connectors 118, 170 may be substantially flat to advantageously position the inductive coupling devices 118A, 178A with respect to one another.

The receptacle 116 may be of any suitable configuration. According to some embodiments, the receptacle 116 is funnel-shaped. According to some embodiments and as illustrated, the receptacle is a female receptacle and the connector 170 is a male connector; however, the reverse may also be employed. The receptacle 116 may be configured to latch with, mate with, locate or place the connector 170 in a prescribed position and orientation with respect to the connector 118 to ensure an effective connection. According to some embodiments, the receptacle 116 and the connector 170 are relatively configured so that the connector 170 self-seats in the receptacle to suitably couple with the connector 118. According to some embodiments, the receptacle 116 includes a conformation or feature configured to guide, orient and/or position the connecting line 160 and/or the connector 170 for effective connection or coupling with the connector 118. For example, with reference to FIG. 6, the receptacle 116 may include tapered side edges 116A that define a slot 116B and converge toward the connector 118.

The connecting line 160 may provide mechanical securement between the base 112 and the base 152 in addition to or instead of a pathway for transfer of energy, data or media. For example, the connecting line 160 may serve as a mechanical anchor line between the bases 112, 152. Such an anchor line may be used to hold one of the bases 112, 152 stationary or to enable one of the bases 112, 152 to tow the other, for example. The connecting line 160 may include suitable mechanical reinforcement elements such as steel cabling or the like.

The bases 112, 152 may be of any suitable construction. As noted above, either or both of the systems 110, 150 may transfer energy, data or media to the other, and may thus include a corresponding energy source, data source or media source. Suitable energy sources that may be embodied in the transferring (or donor) system may include a battery, a generator, a fuel cell, environmental energy extraction device, methane hydrate processor, a mechanical source, and/or a molecular source. Suitable data sources may include data storage devices and/or sensing devices and devices capable of generating data signals.

According to some embodiments, one or both of the bases are connected to, form a part of or include additional operational apparatus. For example, the target base 152 can be connected to or include a monitoring device (e.g., a sonar array) and provide means for transmitting data from the monitoring device to a remote user associated with the base 152 via the UUV 130 and the connecting line 160. By way of further example, the base 112 may float or include a portion that floats on the water surface and includes a radio transmitter. In use, the linking system 110 may receive data from the target 150 (e.g., a sonar array) via the connecting line 160 and transmit this data or associated data to a remote user via the aforementioned radio transmitter.

While the connected objects are shown and described as stationary bases 112, 152 for the purposes of illustration, one or both of the connected bases may be otherwise constructed. One or both of the bases may be fixed (i.e., moored, anchored, settled, attached or otherwise secured so as to be relatively fixed relative to the seafloor), such as a buoy, cable, container, drogue or payload. One or both of the bases may be movable, such as a vehicle, a buoy, a float, a towed body, a drogue or an unanchored sensor, array or transducer.

The bases 112, 152 may be water submersible units. The bases 112, 152 may be operable in, on, under or proximate water. According to some embodiments, one or both of the bases 112, 152 are adapted to rest on the seafloor 32 and may be negatively buoyant or physically anchored thereto. One or both of the bases 112, 152 may be in turn connected to another object or unit such as an antenna, an external sensor, or the like.

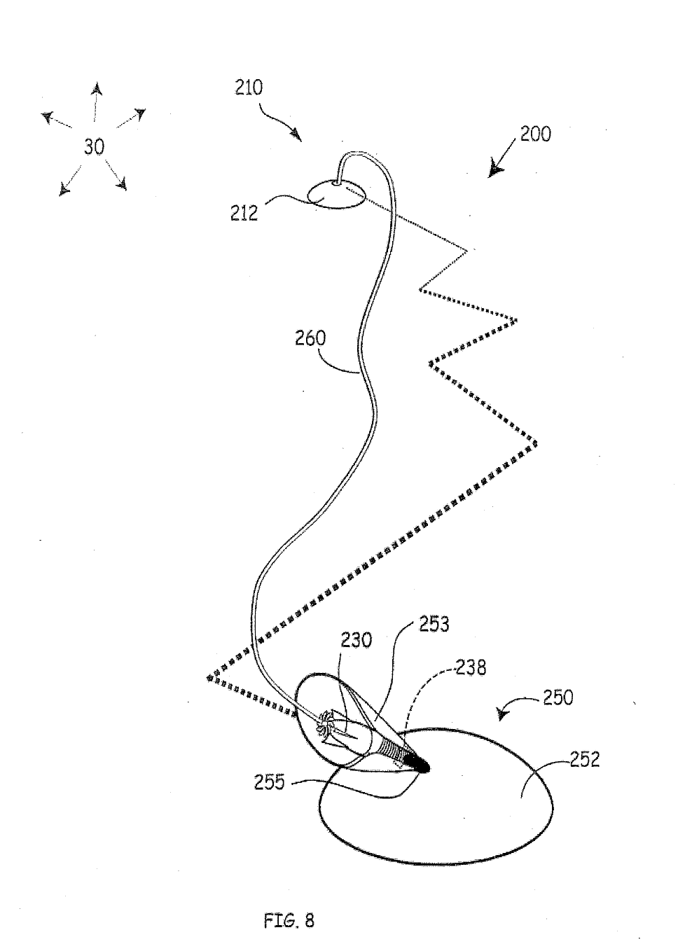

With reference to FIG. 8, a system 200 according to further embodiments of the present invention is shown therein. The system 200 includes a linking system 210 and a target system 250. The linking system 210 corresponds to the linking system 110 except as follows. The linking system includes a UUV 230 corresponding to the UUV 130 except that a connector 238 corresponding to the connector 118 is mounted on the UUV 230. The tether 120 is replaced with a connecting line 260 corresponding to the connecting line 160. The target system 250 corresponds to the target system 150 except that the opening 154, the line 160, the reel 162 and the connector 170 are omitted, a receptacle 253 is mounted on the target base 252 and a target connector 255 is mounted proximate the receptacle 253. The system 200 may be used in the same manner as the system 100 except that the UUV 230 travels into and seats in the receptacle 253 to interconnect the bases 212, 252 with the connecting line 260 rather than retrieving a connecting line from the target system 250. When the connection is no longer desired, the UUV 230 can be released or dislodged from the receptacle 253 and returned to proximate the base 212 (e.g., by a reel corresponding to the reel 122). According to further embodiments (not shown), components corresponding to the opening 154, the line 160, the reel 162 and the connector 170 may be provided in the target base 252 and configured to engage the UUV 230 and/or the connecting line 230 and to draw the UUV 230 into the receptacle 253 using the reel in the manner described above with respect to the connector 170 and the receptacle 118.

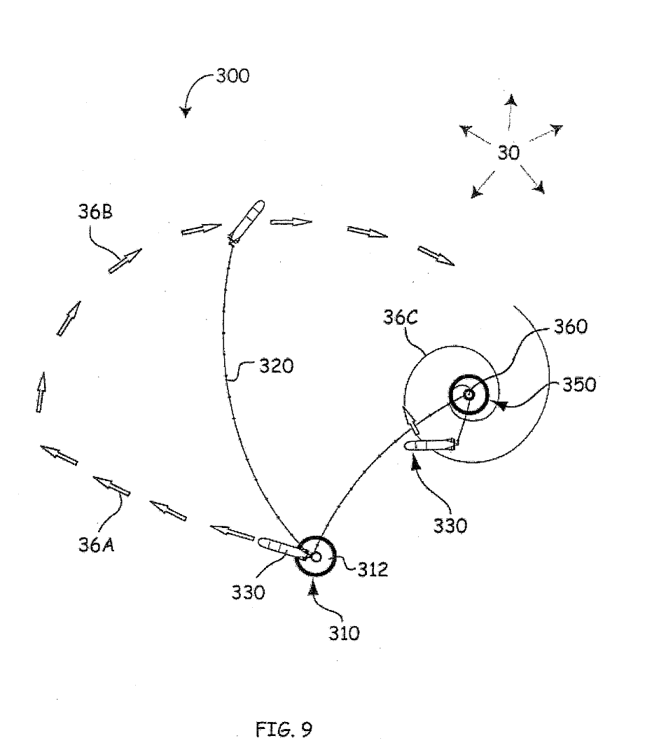

With reference to FIG. 9, a system 300 according to further embodiments of the present invention is shown therein. The system 300 includes a linking system 310 and a target system 350. The target system 350 corresponds to the target system 150. The system 300 corresponds to the system 100 except as follows. In use, the tether 320 has or is paid out to a fixed extension length. According to some embodiments, the extension length is in the range of from about 5 to 1000 meters. The UUV 330 is directed to travel under its propulsion away from the base 312 in a selected or arbitrary radial direction along a first path 36A. The UUV 330 and the tether 320 are relatively configured and coupled such that when the UUV 330 reaches the end of the slack or pay out of the tether 320, the thrust of the UUV 330 induces a tension in the tether 320 that in turn imparts a lateral force on the UUV 330, causing the UUV 330 to change course into a curvilinear path 36B that at least partly circumnavigates the base 312. The propelled path 36B of the UUV 330 circles about the base 312 and brings the tether 320 into engagement with the connecting line 360 of the target system 350, whereupon the UUV 330 encircles the connecting line 360 to capture the connecting line 360 (path 36C). The UUV 330 is then reeled back to the base 312 to connect the connecting line 360 to the base 312 as discussed above with regard to the connecting line 160 and the base 112. According to further embodiments (not shown), the tether 320 may be a connecting line adapted to enable transfer of data, power or media and the UUV 330 may include a connector and be mated to a connector of the target system 350 by reeling in the line 360 once the lines 320 and 360 are entangled. It will be appreciated that the foregoing methods may be executed using the passive mechanism of the arrangement between the line 320 and the UUV 330 and active navigation by the UUV 330 (and a navigation sensor and other navigation electronics) may not be required.

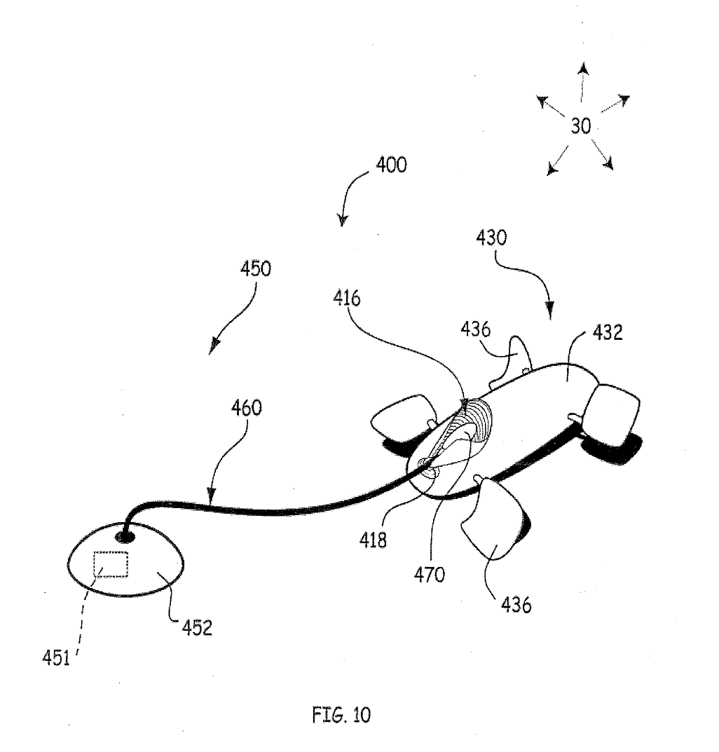

With reference to FIG. 10, a system 400 according to further embodiments of the present invention is shown therein. The system 400 includes a target system 450 and a UUV 430. The target system 450 corresponds to the target system 150 and includes a connector 470 and a connecting line 460. The UUV 430 includes a body 432, a receptacle 416, and a propulsion mechanism 436 (e.g., power driven flippers) and may include further components (e.g., a controller and navigation system) such as those discussed above with regard to the UUV 130. The UUV 430 also includes a connector 418 corresponding to the connector 118. According to some embodiments, the UUV 430 is independent of and not attached to any base. The UUV 430 may be an autonomous vehicle used for intelligence, surveillance or reconnaissance operations, or for oceanography or environmental monitoring.

In use, the UUV 430 collects the connector 470 of the target system 450 in its receptacle 416. The connecting line 460 may be extended by the reel (not shown) to facilitate capture of the connector 470. When received in the receptacle 416, the connector 470 mates with a connector 418 of the UUV 430 to establish a connection as discussed above with regard to the connector 170 and the connector 118. When the connection is no longer desired, the connector 470 may be released or withdrawn from the receptacle 416.

According to some embodiments, the connectors 470 and 418 are inductive connectors and the connection so formed is an inductive connection or coupling. According to some embodiments, the connectors 470 and 418 are inductive connectors constructed in the manner described above to have respective induction elements 118A, 178A and electrically non-conductive covers 118B, 178B. Thus, when the UUV 430 and the target base 452 are so connected, the connecting line 460 and the connection between the connectors 418, 470 can be used to inductively transfer energy or data from the base 452 to the UUV 430 or vice-versa.

According to some embodiments, the base 452 includes a data source as discussed above. According to some embodiments, the base 452 includes an energy source 451 as discussed above. According to some embodiments, the energy source 451 includes a battery cache. According to some embodiments, the energy source 451 includes a fuel cell that can derive electrons directly or indirectly from chemical conversion of a substance, such as organic material, methane hydrate, methane, methanol, or another suitable electron donor. According to some embodiments, the energy source 451 is a bioreactor that can generate energy from a convertible substance.

According to some embodiments, the base 452 includes a supply of fuel media that is transferred to the UUV 430 through the connecting line 460. The base 452 can thereby serve as a “gas station” to which the UUV 430 can tether and connect via the connecting line 460 and receive methanol or other fuel for conversion to electric energy by the UUV's onboard fuel cell.

Connectivity systems as disclosed herein (e.g., the systems 100, 200, 300, 400) may be used multiple times to form and break connections between bases (e.g., the bases 112, 152). Each linking system (e.g., the linking system 110) maybe used with a plurality of different targets (e.g., the target 150). For example, a given linking system may connect via a connecting line or lines to multiple targets in the manners described herein to transfer power, data and/or media to and/or from each target (e.g., in series). For example, the linking system may provide power to a plurality of targets (i.e., serve as a “gas station”) or retrieve data from a plurality of distributed targets (e.g., environmental sensor units).

While UUVs (e.g., the LUVs 130, 230, 330) have been disclosed above as extenders for conveying connecting lines (e.g., the connecting lines 160, 260, 360) between the bases for interconnection, according to some embodiments, other types or configurations of extenders may be employed in place of or in addition to the UUV, such extenders being spatially extendable with respect to the target to retrieve the connecting line from the target or to deliver the connecting line to the target.

While flexible connecting lines (e.g., the connecting lines 160, 260, 360, 460) are described above, other types of linking members or go-betweens may be employed in accordance with some embodiments of the present invention.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed:

1. A system for providing connectivity in an underwater environment, the system comprising:
a linking system including:
a first base; and
an unmanned, submersible mobile unit;
a target remote from the first base; and
a linking member connected to one of the first base and the target;
wherein the mobile unit is operative to autonomously convey the linking member through the underwater environment to the target and/or to the first base to interconnect the first base and the target via the linking member.

2. The system of claim 1 wherein the linking member is a flexible connecting line.

3. The system of claim 2 wherein:
the target includes a target base;
the connecting line forms a part of the target and is joined to the target base; and
the mobile unit is operative to collect the connecting line and to convey the connecting line from proximate the second base to the first base to interconnect the first base and the second base.

4. The system of claim 3 wherein the retriever system includes:
a tether secured to each of the first base and the mobile unit; and
a reel operable to draw the mobile unit toward the first base via the tether line to convey the connecting line to the first base.

5. The system of claim 3 wherein the mobile unit is not attached to the first base.

6. The system of claim 2 wherein the connecting line is secured to each of the first base and the mobile unit and the mobile unit is operative to connect with the target to interconnect the first base and the target.

7. The system of claim 6 wherein the target includes a second base and a target line extending from the second base to facilitate engagement between the target and the mobile unit.

8. The system of claim 7 wherein the target includes a target line reel operable to draw the target line toward the second base.

9. The system of claim 2 wherein the mobile unit includes a navigation system to direct the mobile unit to the target.

10. The system of claim 9 wherein the target includes an emitter to emit a navigation signal detectable by the navigation system of the mobile unit.

11. The system of claim 2 wherein the linking system includes a control line secured to each of the first base and the mobile unit such that the mobile unit will travel in a first direction until a line tension is induced in the control line, whereupon the control line will force the mobile unit to change direction of travel.

12. The system of claim 2 wherein:
the linking system includes a first connector; and
the target includes a second connector configured to releasably engage and couple with the first connector.

13. The system of claim 12 wherein one of the target and the linking system includes a female receptacle configured to receive and direct at least one of the first connector and the second connector into engagement with the other.

14. The system of claim 12 wherein:
the linking system includes a tether line secured to each of the first base and the mobile unit; and
the second connector includes a snag structure configured to engage and capture the tether line.

15. The system of claim 2 wherein the linking system, the target and the connecting line are configured to transfer at least one of data, power and media between the first base and the target via the connecting line when the first base is interconnected to the target by the connecting line.

16. The system of claim 15 wherein the first connector is configured to inductively couple with the second connector to inductively transmit power and/or data between the target and the linking system.

17. The system of claim 16 wherein the first conductor is configured to releasably engage the second connector.

18. A method for providing connectivity in an underwater environment, the method comprising:
providing a linking system including:
a first base; and
an unmanned, submersible mobile unit; and
using the mobile unit, autonomously conveying a linking member connected to one of the first base and a remote target through the underwater environment to the target and/or to the first base to interconnect the first base and the target via the linking member.

19. A system for providing connectivity in an underwater environment, the system comprising:
a submersible first unit including a first connector; and
a submersible second unit including a second connector configured to inductively couple with the first connector to inductively transmit power and/or data between the first and second units.

20. The system of claim 19 wherein the second connector is configured to releasably engage the first connector.

21. The system of claim 19 wherein the first unit is an unmanned submersible vehicle.

22. The system of claim 21 wherein the second unit is a submersible stationary unit.

23. The system of claim 19 wherein the first connector includes a female receptacle configured to receive at least a portion of the second connector.
